(19) United States
(12) Patent Application Publication
(10) Pub. No.: US 2002/0160083 A1
(43) Pub. Date: Oct. 31, 2002

(54) Process for coating sugar-free boiled sweets

(76) Inventor: Guillaume Ribadeau-Dumas, Verlinghem (FR)

Correspondence Address: HENDERSON & STURM LLP, 1213 MIDLAND BUILDING, 206 SIXTH AVENUE, DES MOINES, IA, 50309-4076, US

(21) Appl. No.: 10/080,719

(22) Filed: Feb. 22, 2002

(30) Foreign Application Priority Data
Feb. 27, 2001 (FR) FR 01 02677

(51) Int. Cl. A23L 1/00

(52) U.S. Cl. 426/89

(57) ABSTRACT

The invention relates to a process for coating sugar-free boiled sweets, allowing the creation of a hard and translucent coating, comprising the application of a coating syrup, characterized in that the said syrup comprises at least one polyol, at least one high molecular weight polysaccharide and at least one fat.

It also relates to a sugar-free boiled sweet obtained according to the said process.

It relates, in addition, to a coating syrup characterized in that it comprises at least one polyol, at least one high molecular weight polysaccharide and at least one fat.

The subject of the present invention is a process for coating sugar-free boiled sweets allowing easy and rapid creation of a coating at the surface of a boiled sweet.

It also relates to the coated boiled sweets obtained according to the said process.

Boiled sweets, also commonly called hard sweets or hard boiled candies, are solid and essentially amorphous confectionery products.

In France and abroad, numerous confectionery manufacturers now market sugar-free confectioneries. Their objective is to satisfy the needs of an increasing number of consumers who are more concerned than previously with their diet and a healthy lifestyle. The beginning of sugar-free confectionery goes back to the 1950s, when the first industrial boiled sweets appeared on the German market. They were sorbitol-based products obtained by casting. This polyol replaced both the sugar and the glucose syrups traditionally used in this application. The sorbitol-based boiled sweets are atypical products because they are essentially crystalline.

Subsequently, the development of the maltitol syrup LYCASIN® 80/55, a noncariogenic and noncrystallizable product developed by the applicant, made possible the manufacture of completely amorphous hard sweets comparable to traditional boiled sweets in terms of vitreous state. Other polyols have now appeared on the market with their advantages and disadvantages for the manufacture of sugar-free boiled sweets.

Boiled sweets are hygroscopic products which, when stored under normal conditions of temperature and humidity, tend to absorb the moisture from the atmosphere and therefore tend to become sticky. To avoid boiled sweets sticking to each other, which would make their consumption difficult, they are generally individually wrapped, for example using wrappers which are impervious to water vapour to a greater or lesser degree. The wrapped boiled sweets are generally packaged in packets which also contribute towards making a barrier which is impervious to a greater or lesser degree between the boiled sweet and the atmospheric moisture, which further enhances the preservation of the boiled sweets.

The conventional boiled sweets most frequently encountered on the market, containing about 2 to 5% of residual water and whose dry matter content is generally composed of 10 to 60% of sucrose and 40 to 90% of glucose syrup dry matter, and the sugar-free boiled sweets essentially based on maltitol syrups are generally individually wrapped and packaged in packets.

To reduce the cost of their wrapping materials and to satisfy the needs of consumers who desire practical products without individual wrappings, the manufacturers of boiled sweets have always sought to reduce their hygroscopicity in order to allow them to be marketed without individual wrappings in inexpensive packagings such as cardboard boxes for example.

Several solutions have been proposed. Isomalt has made it possible to satisfy this concern for stability, making impervious, sophisticated and expensive packaging no longer necessary.

Isomalt is, however, an expensive product and is therefore poorly suited as a filler for products manufactured in large quantities.

Other solutions currently exist for producing boiled sweets which are sufficiently stable during storage.

The first consists in producing boiled sweets based on sorbitol. This polyol allows the production of boiled sweets which remain stable to moisture by virtue of a microcrystallization of the polyol in the bulk and at the surface. This microcrystallization is not visible to the naked eye and the boiled sweet is translucent immediately after its manufacture. However, over time, it tends to become white at the surface, which reduces its attractiveness. Furthermore, the sorbitol-based boiled sweets cannot be shaped, they cannot be cast and they harden very slowly (in general more than one hour) because a crystallization process is involved. The hardening of the other vitreous boiled sweets depends only on the rate of cooling of the boiled sweets and only lasts for a few minutes.

The second solution consists in frosting the boiled sweet, as is described, for example, in Patent EP 0 630 575 of which the applicant is the proprietor. The frosting consists in applying at the surface of the boiled sweet a crystallizable syrup, most often sucrose. The crystallization of the sucrose at the surface of the boiled sweet thus creates a barrier to aqueous exchanges. However, the frosting removes the translucence criterion from the frosted boiled sweet, the latter having a whitish appearance. Another solution consists in a technique called oiling, which is a coating using mono- and diglyceride type fats, essentially intended for gelled confectioneries generally of the pharmaceutical type. The disadvantage of this method is that it does not create an effective barrier to the moisture from the ambient air, on the one hand, and, on the other hand, that it confers on the confectioneries a fatty texture not suited in particular to carton packaging, and unpleasant for the consumer.

The third solution consists in providing a particular carbohydrate composition which makes it possible to obtain a sugar-free boiled sweet stable to moisture and heat, which does not have a tendency, over time, to become opaque and white at the surface or in the centre.

Several compositions have thus been proposed. For example, Patent EP 0 561 089, whose applicant is the proprietor, proposes a composition containing hydrogenated saccharides having a particular profile selected so as to confer increased stability on the boiled sweets. These are not, however, intended for the manufacture of uncoated boiled sweets since the boiled sweets prepared with this type of composition have to be necessarily wrapped. Other solutions based on isomalt exist for producing boiled sweets which are sufficiently stable to be able to be marketed without individual wrappings.

It is indeed possible to use mixtures containing 80% of isomalt and 20% of maltitol syrup, or 20% of glucose syrup, or 20% of polydextrose. These mixtures are, however, expensive.

It is also possible to use the process described in Patent EP 518 770, of which the applicant is proprietor. This process, however, proves to be fairly complicated.

The aim of the invention is therefore to remedy the disadvantages of the prior art and to provide a novel process for coating sugar-free boiled sweets, which satisfy much better the needs of confectionery manufacturers and the various requirements of practical use, that is to say possessing a markedly improved stability to storage without the translucence of the boiled sweet being impaired.

At the end of exhaustive research studies, the applicant has had the merit of finding that this aim could be achieved and that, against all expectations, it was possible to prepare a stable sugar-free boiled sweet, in particular which is not wrapped, when it was coated according to an appropriate and particular process.

The boiled sweet in accordance with the invention may be described as stable since, over time and without individual wrapping, it does not tend:

either to become sticky,

or to grain, or to turn, becoming opaque and white at the surface or at the centre,

or to become deformed at the summer temperatures characteristic of temperate climates.

Coating is a unit operation used in many fields and in particular those of food or pharmaceutical confectionery. This operation consists in creating a coating at the surface of the products which it is desired to protect for various reasons, while making them attractive visually or tastewise.

In the context of the present invention, interest is directed towards a particular coating technique which consists in protecting sugar-free boiled sweets so that they can be marketed without individual wrapping, without exhibiting sticking problems during their storage. The marketing of boiled sweets in cartons or metal boxes, without wrapping, while preserving the initial appearance of the boiled sweet, is thus aimed at.

The techniques of hard or soft sugar-coating, frosting, sanding, wet crystallization which do not consist of a hard and translucent coating not modifying the initial appearance of the boiled sweet are not therefore covered by the present invention.

The applicant has discovered that, surprisingly and unexpectedly, by applying a particular coating process advantageously using a coating syrup comprising a polyol as substitute for sugar, which has the advantage of being very quick and simple to set up industrially, it was possible to prepare coated boiled sweets of very high quality, which are not sticky and whose appearance or texture does not vary significantly over time.

Pursuing its research work, the applicant observed that the use of a coating syrup comprising at least one polyol, at least one high molecular weight saccharide polymer and at least one fat was an essential factor making it possible to achieve the aim set.

The subject of the present invention is therefore a process for coating sugar-free boiled sweets, allowing the creation of a hard and translucent coating, comprising the application of a coating syrup, characterized in that the said syrup comprises at least one polyol, at least one high molecular weight polysaccharide and at least one fat.

According to a general embodiment of the invention, the process consists in homogeneously moistening the surface of the boiled sweets to be coated using the said coating syrup, and in stirring them so as to ensure good distribution of the coating syrup. The process in accordance with the invention requires at least one, but preferably two applications of the said coating syrup.

The coating syrup may be applied to the boiled sweets placed in a coating pan. This may have an ordinary shape, that is to say a tulip shape with an inclined axis of rotation or a cylindrical shape with a horizontal axis.

The boiled sweets will have a preferably oval or spherical shape.

As regards the composition of the sugar-free boiled sweet to be coated, any type of syrup may be used, knowing that the aim is always to obtain a boiled sweet which is sufficiently stable before coating. For example, it may be possible to prepare boiled sweets from maltitol syrups, such as in particular LYCASIN®HBC developed by the applicant, alone or mixed with mannitol, these syrups being known to confer satisfactory stability on wrapped boiled sweets.

Preferably, the polyol(s), the high molecular weight polysaccharide(s) and the fat(s) are mixed prior to the coating so as to constitute the said coating syrup.

According to an advantageous variant of the invention, the said process will comprise in particular the application of a coating syrup comprising at least one polyol chosen from the group consisting of maltitol, mannitol, erythritol, lactitol and isomalt, and mixtures thereof.

The expression high molecular weight polysaccharide is understood to mean for the purposes of the present invention plant gums such as in particular gum arabic, gum tragacanth, and modified or unmodified starches, microcrystalline cellulose and derivatives thereof, which are capable of acting as plant gums in a process according to the invention. It means in particular maltodextrins, poly-dextrose, oligosaccharides such as in particular fructooligosaccharides, galactooligosaccharides, isomaltooligosaccharides, maltooligosaccharides, inulin and hydrogenated or non-hydrogenated branched maltodextrins as described in Patent Application EP 1 006 128, of which the applicant is proprietor, which have between 15 and 35% of 1-6 glucoside bonds, a reducing sugar content of less than 20%, a polydispersity value of less than 5 and a number-average molecular mass Mn at most equal to 4500 g/mol, and mixtures thereof.

According to another variant of the process according to the invention, the said coating syrup comprises, in addition, at least one silicate. This will be in particular magnesium silicate, also called “talc” by a person skilled in the art.

As regards the fat, any type of fat which can be used in food or pharmaceutical confectionery is suitable. There may be mentioned, by way of example, paraffin and petroleum jelly, alone or mixed with each other.

The expression fats also includes for the purposes of the present invention waxes, such as for example beeswax, carnauba wax, candellilla wax, shellac and microcrystalline wax.

It goes without saying that in practice, depending on the intended applications, the said coating syrup may also comprise one or more constituents chosen, without this list being limiting, from the group comprising flavourings, colourings, intense sweeteners, acids, plant extracts and vitamins, alone or mixed with each other.

According to another variant of the process according to the invention, the said coating syrup comprises at least one maltitol syrup of the LYCASIN®HBC type such as those described in Patent EP 0 561 089, of which the applicant is proprietor, and at least one fat.

The invention also relates to a sugar-free boiled sweet coated according to the said process.

The invention relates, in addition, to a coated sugar-free boiled sweet, characterized in that its coating comprises at least one polyol, at least one high molecular weight polysaccharide and at least one fat. According to a variant of the invention, the coating for the said boiled sweet comprises, in addition, at least one silicate and preferably a magnesium silicate.

To the knowledge of the applicant, such coated sugar-free boiled sweets, stable during storage without wrapping, constitute novel industrial products.

According to an advantageous variant of the invention, the said coating comprises at least one polyol chosen from the group consisting of maltitol, mannitol, erythritol, lactitol and isomalt, and mixtures thereof. Preferably, the coating comprises maltitol.

The coated boiled sweet according to a process in accordance with the invention has an increased storage stability. More precisely, it exhibits a water regain which is much lower than that of the uncoated boiled sweet.

According to an advantageous variant of the invention, very significant results, in terms in particular of stability, were obtained by coating according to a process in accordance with the invention a sugar-free boiled sweet prepared, before coating, from a maltitol syrup. The expression maltitol syrup is understood to mean for the purposes of the invention syrups of the LYCASIN®HBC type marketed by the applicant. According to a preferred variant, very good results are obtained by preparing sugar-free boiled sweets, before coating, from mixtures of the said maltitol syrups with up to 10% by weight of mannitol.

The invention finally relates to a coating syrup, characterized in that it comprises at least one polyol, at least one high molecular weight polysaccharide and at least one fat.

Preferably, the said polyol is chosen from the group consisting of maltitol, mannitol, erythritol, lactitol and isomalt and mixtures thereof. The said coating syrup advantageously comprises at least 5% by weight of the said polyol, and at most 70% by weight. Above this content, undesirable crystallization phenomena are indeed observed which mean that the coating becomes opaque.

More preferably still, the said polysaccharide is chosen from the group consisting of plant gums, modified or unmodified starches, microcrystalline cellulose and derivatives thereof, polydextrose, oligosaccharides and hydrogenated or non-hydrogenated branched maltodextrins having between 15 and 35% of 1-6 glucoside bonds, a reducing sugar content of less than 20%, a polydispersity value of less than 5 and a number-average molecular mass Mn at most equal to 4500 g/mol, alone or as a mixture. The coating syrup will advantageously comprise 0.5 to 30% by weight of the said polysaccharide.

As regards the fat, it will be present in the coating syrup in an amount of 10 to 40% by weight.

As regards the silicate, when it is present, the coating syrup will preferably comprise 0.5 to 30% by weight thereof.

The coating syrup according to the invention can comprise up to 40% by weight of water. Preferably, it will comprise 10 to 30%, and more preferably 20 to 30%, of water.

The remainder to 100% is constituted by water as well as possibly, depending on the applications aimed at, any additive usually used in confectionary, such as flavourings, colourings, intense sweeteners, acids, vitamins, plant extracts.

Very good results were obtained with a coating syrup comprising 30 to 50% by weight of polyols, 1 to 10% by weight of high molecular weight polysaccharide, 20 to 30% by weight of fat and 5 to 15% by weight of silicate.

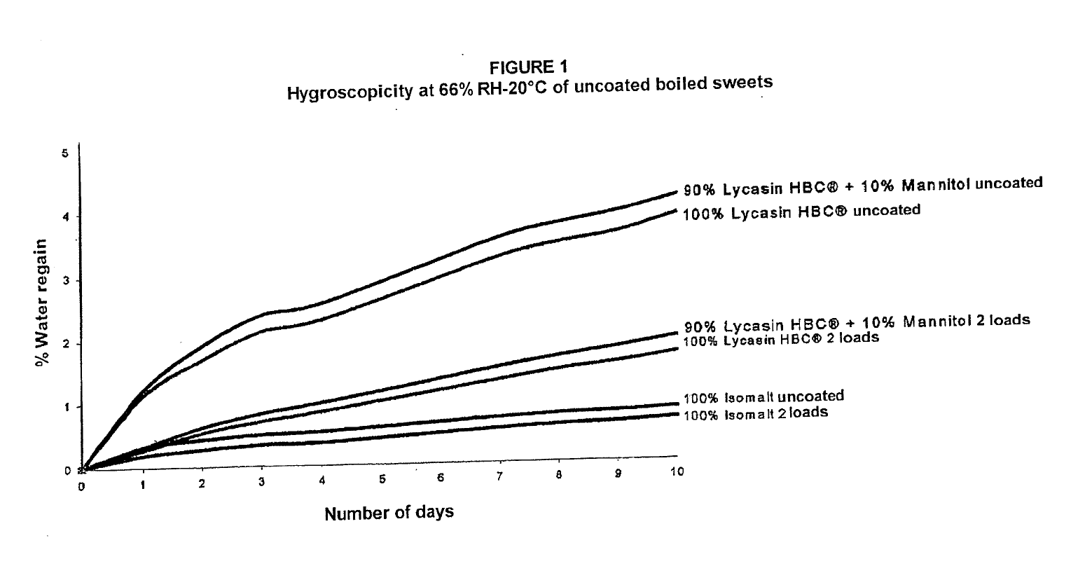

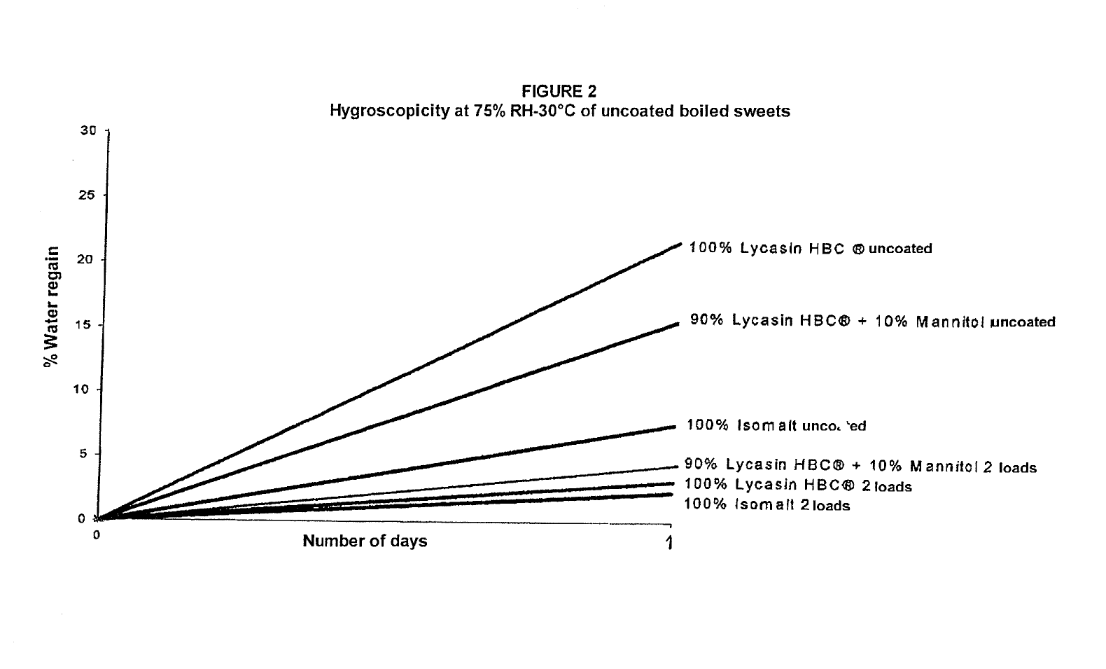

The invention will be understood more clearly with the aid of the examples which follow and of FIGS. 1 to 2 relating thereto, which are intended to be illustrative and not limiting.

### EXAMPLE 1

1. Preparation of the Boiled Sweets

Formulas:

| Identification | | | | Glass |
|---|---|---|---|---|
| of the | | Boiling | Water | transition |
| uncoated | Composition | temper- | content | temper- |
| boiled sweets | used | ature | (%) | ature (° C.) |
| T | 100% isomalt | 190° C. | 1.9% | 46.0° C. |
| | (control) | | | |
| S1 | 100% | 153° C. | 2.7% | 42.1° C. |
| | LYCASIN ®HBC | | | |
| S2 | 90% | 190° C. | 1.7% | 45.1° C. |
| | LYCASIN ®HBC | | | |
| | 10% mannitol | | | |

2. Preparation of the Coating Syrup

Formula:

| | |
|---|---|
| maltitol | 380.0 |
| (MALTISORB ® P200) | |
| water | 230.0 |
| gum arabic | 30.0 |
| talc | 120.0 |
| fat | 240.0 |
| | 1000.0 |

Introduce boiling water into a planetary mixer.

Add powdered gum arabic, mix for 5 minutes until homogenization is obtained.

Add the maltitol, mix until a homogeneous solution is obtained.

Mix with the fat until homogenization is obtained.

Add the talc, mix until a homogeneous suspension is obtained.

Keep the coating suspension thus obtained at 80° C. on a water bath.

3. Coating of the Boiled Sweets

Introduce 200 g of boiled sweets into a coating pan.

Preheat them in the region of 30-35° C. with hot and dry air.

Add 1 ml of coating syrup at 80° C. to these boiled sweets at 30-35° C. in a rotating pan. Allow the distribution to proceed for 10 minutes.

Optionally add a second load of 1 ml of coating syrup.

Allow the coated boiled sweets to dry for 12 hours at 50% relative humidity and at 20° C. before packaging.

The coated boiled sweets are identified in accordance with the preceding example in the following manner: TE, SE1 and SE2.

Appearance of the Boiled Sweets After Coating

The coating practically does not modify the appearance of the boiled sweets: they are translucent.

### EXAMPLE 2

Stability at 66% Relative Humidity and 20° C.

The regain of water by the coated boiled sweets according to Example 1 was studied in comparison with uncoated boiled sweets, as they are or in carton boxes, during a storage period of 10 days at 66% relative humidity and 20° C.

The results are illustrated by FIG. 1.

This figure shows that the coating considerably reduces the hygroscopicity of the boiled sweets, regardless of their composition.

Conclusion: the coated boiled sweets according to the invention, T, S1 and S2, do not stick to their support after 10 days, whereas the uncoated boiled sweets according to the prior art, SE1 and SE2, stick to their support.

Stability at 75% Relative Humidity and 30° C.

The regain of water by the coated boiled sweets according to Example 1 was studied in comparison with uncoated boiled sweets, as they are or in carton boxes, during a storage period of 1 day at 70% relative humidity and 30° C.

The results are illustrated by FIG. 2.

This figure shows that the hygroscopicity of the boiled sweets S1 and SE2 is less than the control without coating T.

The appearance of the boiled sweets after storage shows that the boiled sweets SE1 and SE2 are more attractive, because they are less grained than the boiled sweets TE.

The boiled sweets SE1 and SE2 stick slightly to their support, but not more than the controls with isomalt.

The studies of stability in carton boxes show that neither SE1 nor SE2 sticks without individual wrapping, whether at 66% RH or at 70% RH, whereas S1 and S2 stick.

These boiled sweets according to the invention can therefore be marketed uncoated, and grain less than boiled sweets with isomalt.

1. Process for coating sugar-free boiled sweets, allowing the creation of a hard and translucent coating, comprising the application of a coating syrup, characterized in that the said syrup comprises at least one polyol chosen from the group consisting of maltitol, mannitol, erythritol, lactitol and isomalt, alone or as a mixture, at least one high molecular weight polysaccharide and 10 to 40% by weight of at least one fat.

2. Coating process according to claim 1, characterized in that the said coating syrup comprises, in addition, at least one silicate.

3. Coating process according to either of claims 1 and 2, characterized in that the high molecular weight polysaccharide is chosen from the group consisting of plant gums, modified or unmodified starches, microcrystalline cellulose and derivatives thereof, polydextrose, oligosaccharides and hydrogenated or nonhydrogenated branched maltodextrins having between 15 and 35% of 1-6 glucoside bonds, a reducing sugar content of less than 20%, a polydispersity value of less than 5 and a number-average molecular mass Mn at most equal to 4500 g/mol, alone or as a mixture.

4. Coating process according to any one of claims 1 to 3, characterized in that the said coating syrup comprises maltitol.

5. Coating process according to any one of claims 2 to 4, characterized in that the silicate is a magnesium silicate.

6. Sugar-free boiled sweet coated according to a process in accordance with any one of claims 1 to 5.

7. Coated sugar-free boiled sweet, characterized in that its coating is hard and translucent and comprises at least one polyol chosen from the group consisting of maltitol, mannitol, erythritol, lactitol and isomalt, alone or as a mixture, at least one high molecular weight polysaccharide and 10 to 40% of at least one fat.

8. Boiled sweet according to claim 7, characterized in that its coating comprises, in addition, at least one silicate.

9. Boiled sweet according to any one of claims 6 to 8, characterized in that it is prepared, before coating, from a maltitol syrup mixed with at most 10% by weight of mannitol.

10. Coating syrup, characterized in that it comprises at least one polyol chosen from the group consisting of maltitol, mannitol, erythritol, lactitol and isomalt, alone or as a mixture, at least one high molecular weight polysaccharide and 10 to 40% by weight of at least one fat.

11. Coating syrup according to claim 10, characterized in that the said polysaccharide is chosen from the group consisting of plant gums, modified or unmodified starches, microcrystalline cellulose and derivatives thereof, polydextrose, oligosaccharides and hydrogenated or non-hydrogenated branched maltodextrins having between 15and 35% of 1-6 glucoside bonds, a reducing sugar content of less than 20%, a polydispersity index of less than 5 and a number-average molecular mass Mn at most equal to 4500 g/mol, alone or as a mixture.

12. Coating syrup according to any one of claims 10 and 11, characterized in that it comprises 30 to 50% by weight of at least one polyol chosen from the group consisting of maltitol, mannitol, erythritol, lactitol and isomalt, alone or as a mixture, 1 to 10% by weight of high molecular weight polysaccharides, 20 to 30% by weight of fat and 5 to 15% by weight of silicate.
